(19) United States
(12) Patent Application Publication
(10) Pub. No.: US 2021/0107341 A1
(43) Pub. Date: Apr. 15, 2021

(54) VEHICLE BACK DOOR INNER PANEL

(71) Applicant: DAIHATSU MOTOR CO., LTD., Ikeda-shi, Osaka (JP)

(72) Inventors: Jun MOTOHASHI, Ikeda-shi, Osaka (JP); Shin ITO, Ikeda-shi, Osaka (JP); Kohei MACHIYA, Ikeda-shi, Osaka (JP); Sadayuki SHIMIZU, Ikeda-shi, Osaka (JP); Singo OUE, Ikeda-shi, Osaka (JP); Naoya IKEDA, Ikeda-shi, Osaka (JP); Yasushi YAMADA, Ikeda-shi, Osaka (JP)

(21) Appl. No.: 16/464,487

(22) PCT Filed: Nov. 27, 2017
(86) PCT No.: PCT/JP2017/042363

§ 371 Date: May 28, 2019

(30) Foreign Application Priority Data
Nov. 29, 2016 (JP) 2016-231044
Mar. 30, 2017 (JP) 2017-068974
Jul. 11, 2017 (JP) 2017-135369
Jul. 12, 2017 (JP) 2017-135961

(51) Int. Cl. B60J 5/10

(52) U.S. Cl. CPC B60J 5/107

(57) ABSTRACT

The present disclosure provides a vehicle back door inner panel containing synthetic resin as a constituent material. The inner panel includes an opening, an upper portion, a skirt portion, and two side portions. The opening is provided with a back window. The upper portion is closer to a vehicle top than the opening, extending in a vehicle width direction. The upper portion is provided with two door hinge portions at left and right ends. The skirt portion is closer to a vehicle bottom than the opening. The skirt portion is provided with a latch attachment portion at a lower end. The side portions are on left and right sides of the opening, extending in a vehicle top-bottom direction. The side portions connect the upper portion and the side portions. The side portions have a hat-shaped cross section open toward a rear side of the vehicle. The skirt portion has two connecting portions each having a hat-shaped cross section open toward the rear side of the vehicle. The connecting portions are at left and right sides of an upper end of the skirt portion. The connecting portions are connected to lower ends of the side portions. The skirt portion has a skeletal portion open toward the rear side of the vehicle. The skeletal portion extends obliquely upward relative to the vehicle width direction from left and right sides of the latch attachment portion to reach the connecting portions. The side portions, connecting portions and skeletal portion form left and right skeletal structures continuous from the respective door hinge attachment portions to the latch attachment portion.

### TECHNICAL FIELD

The present disclosure relates to a synthetic resin inner panel that constitutes a back door of a vehicle.

### BACKGROUND ART

There is known a back door made of synthetic resin instead of a conventional sheet metal, in order to reduce the weight of a vehicle and the manufacturing cost. A synthetic resin back door has disadvantages over a sheet metal back door in that it has low rigidity and is prone to deformation. The synthetic resin back door includes an inner panel on the front side and an outer panel on the rear side of the vehicle, with the outer panel joined to the inner panel. Of these panels, the inner panel provides the strength and rigidity of the back door.

Under the circumstances above, Patent Document 1 discloses a back door reinforcing structure having a sheet metal reinforcement, in which the reinforcement is provided in a hollow portion between an inner panel and an outer panel that constitute a synthetic resin back door. The reinforcing structure improves the rigidity of the back door both in the vehicle top-bottom direction and in the vehicle width direction, thus suppressing the deformation of the back door as a whole. However, the arrangement of the sheet metal reinforcement unduly increases the weight of the back door, thereby lowering the fuel efficiency of the vehicle. Furthermore, it also requires a greater number of parts for the back door and additional assembling steps.

### SUMMARY OF THE INVENTION

In view of the above circumstances, an object of the present disclosure is to provide a vehicle back door inner panel capable of improving rigidity while reducing weight.

The present disclosure provides a vehicle back door inner panel containing synthetic resin as a constituent material. The vehicle back door inner panel includes an opening, an upper portion, a skirt portion, and a pair of side portions. The opening is to be provided with a back window. The upper portion is positioned closer to a top of a vehicle than is the opening, and extends in a vehicle width direction. The upper portion is provided with a pair of door hinge portions at left and right ends thereof. The skirt portion is positioned closer to a bottom of the vehicle than is the opening. The skirt portion is provided with a latch attachment portion at a lower end thereof. The pair of side portions are positioned at left and right sides of the opening, and extend in a vehicle top-bottom direction. The pair of side portions connect the upper portion and the side portions. The pair of side portions each have a hat-shaped cross section that is open toward a rear side of the vehicle. The skirt portion has a pair of connecting portions each having a hat-shaped cross section that is open toward the rear side of the vehicle. The pair of connecting portions are positioned at left and right sides of an upper end of the skirt portion. The pair of connecting portions are connected to lower ends of the pair of side portions. The skirt portion has a skeletal portion that is open toward the rear side of the vehicle. The skeletal portion extends obliquely upward relative to the vehicle width direction from both left and right sides of the latch attachment portion, and reaches the pair of the connecting portions. A combination of the side portions, the connecting portions and the skeletal portion forms a pair of left and right skeletal structures that are continuous from the pair of door hinge attachment portions to the latch attachment portion.

Other features and advantages of the present disclosure will become apparent from the detailed description given below with reference to the accompanying drawings.

### BRIEF DESCRIPTION OF THE DRAWINGS

FIG. 1 is a perspective view showing a vehicle back door inner panel seen from the front of a vehicle, according to an embodiment of the present disclosure.

FIG. 2 is a perspective view showing the inner panel of FIG. 1 from the rear side of the vehicle.

FIG. 3 is a schematic front view (seen from the rear side of the vehicle) showing the inner panel of FIG. 1.

FIG. 4 is a detailed front view (seen from the rear side of the vehicle) showing the inner panel of FIG. 1.

FIG. 5 is a sectional view along line V-V in FIG. 4.

FIG. 6 is a sectional view along line VI-VI in FIG. 4.

FIG. 7 is a sectional view along line VII-VII in FIG. 4.

FIG. 8 is a sectional view along line VIII-VIII in FIG. 4.

### MODE FOR CARRYING OUT THE INVENTION

Modes for carrying out the present disclosure (referred to as “embodiments” below) will be described with reference to the accompanying drawings.

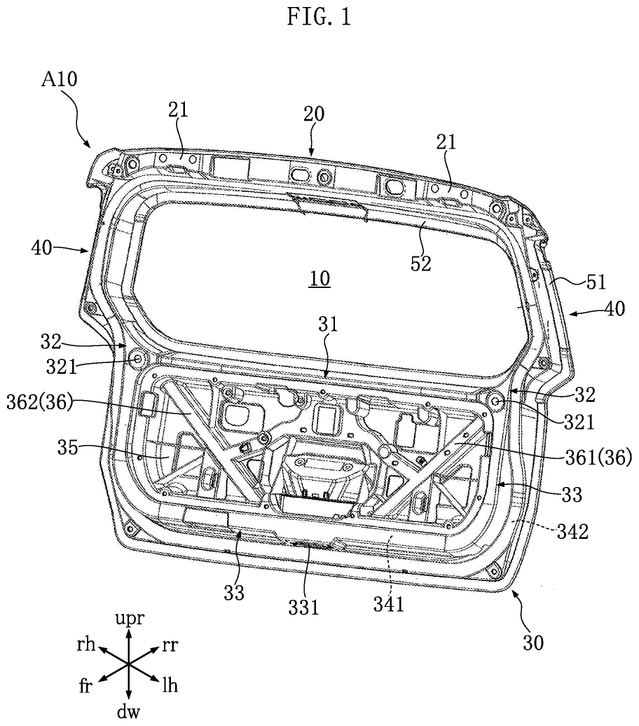

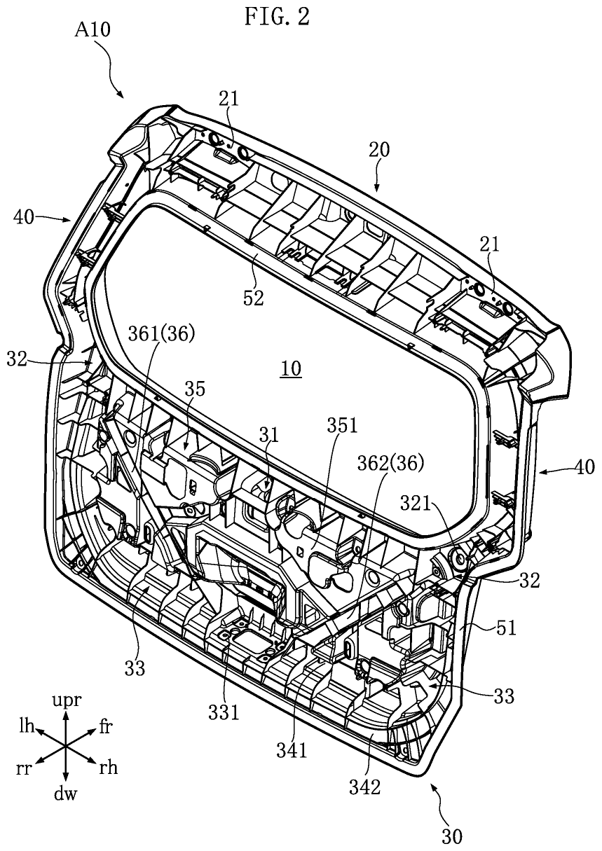

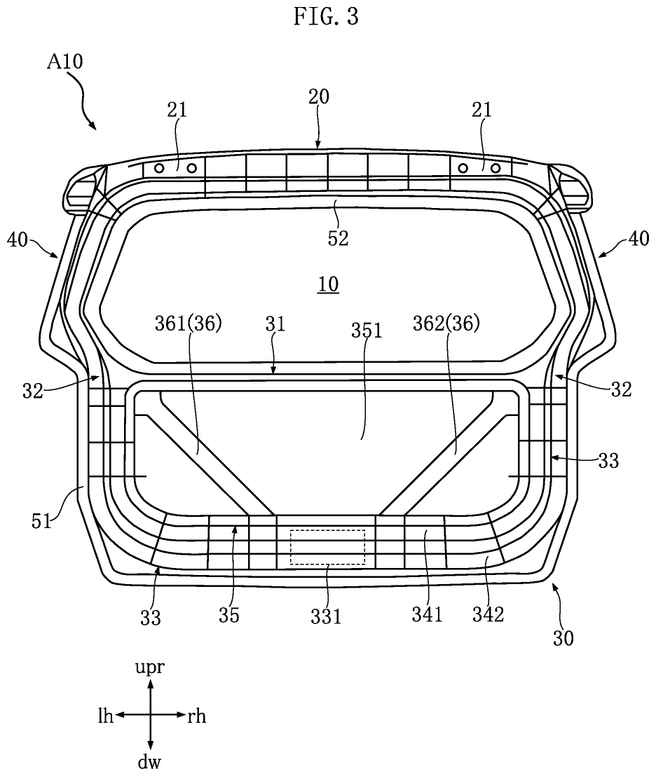

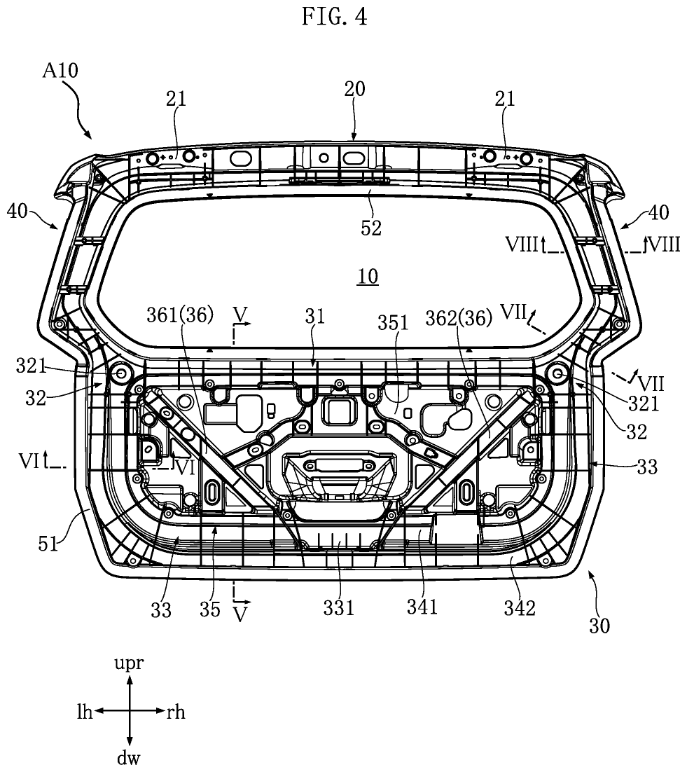

With reference to FIGS. 1 to 8, the following describes a vehicle back door inner panel (hereinafter “inner panel A10”) according to an embodiment of the present disclosure.

For convenience of explanation, “upr” in the figures denotes a vehicle up direction, “dw” denotes a vehicle down direction, “fr” denotes a vehicle front direction, “rr” denotes a vehicle rear direction, “rh” denotes a vehicle right direction, and “lh” denotes a vehicle left direction. In the following description, the terms “upper” and “lower” respectively indicate an upper side and a lower side in a vehicle top-bottom direction, unless otherwise specified. The terms “front” and “rear” respectively indicate a front side and a rear side in a vehicle longitudinal direction, unless otherwise specified. The terms “left” and “right” respectively indicate a left side and a right side in a vehicle lateral direction (vehicle width direction), unless otherwise specified.

A vehicle back door (hereinafter, simply “back door”) is arranged to close a rear opening of a vehicle, and includes an inner panel A10 and an outer panel (not shown) as constituent elements. The inner panel A10 is positioned on a front and inner side of the vehicle, and the outer panel is positioned on a rear and outer side of the vehicle. The inner panel A10 and the outer panel each contain synthetic resin as a constituent material. The back door is formed by joining the outer panel to the inner panel A10 and joining a back window (not shown) to the outer panel from the rear side of the vehicle. The constituent material of the inner panel A10 is polypropylene (PP) containing glass fiber (GF). The inner panel A10 is formed as a single component by injection molding. In the present embodiment, the inner panel A10 exhibits an off-white color.

As shown in FIGS. 1 to 4, the inner panel A10 includes an opening 10, an upper portion 20, a skirt portion 30, and a pair of side portions 40.

As shown in FIGS. 1 to 4, the opening 10 is an open area surrounded by the upper portion 20, the skirt portion 30, and the pair of side portions 40. After the back door is formed, a back window (not shown) is attached for the opening 10 from the rear side of the vehicle to close the opening 10.

As shown in FIGS. 1 to 4, the outer edges of the skirt portion 30 and side portions 40 are formed with a first flange 51 protruding from the inner panel A10 outward in the vehicle width direction or in the vehicle down direction. Also, as shown in FIGS. 1 to 4, the inner edges of the upper portion 20, the skirt portion 30, and the pair of side portions 40, which are adjacent to the opening 10, are formed with a second flange 52. The second flange 52 protrudes toward the opening 10 in the vehicle top-bottom direction and in the vehicle width direction. The second flange 52 surrounds the opening 10. The outer panel is attached to the inner panel A10 in a manner such that the outer panel abuts the rear surfaces (the surfaces facing the rear of the vehicle) of the first flange 51 and second flange 52. To fix them, use may be made of a polyurethane-based adhesive, for example.

As shown in FIGS. 1 to 4, the upper portion 20 is positioned closer to the top of the vehicle than is the opening 10, and extends in the vehicle width direction. The upper portion 20 provides a beam structure in the inner panel A10. The upper portion 20 is provided with a pair of door hinge attachment portions 21. The pair of door hinge attachment portions 21 are positioned at the left and right ends of the upper portion 20. Each of the door hinge attachment portions 21 is provided with a door hinge (not shown) and a steel reinforcing member (not shown) for the door hinge. The door hinge is attached from the front side of the vehicle and the steel reinforcing member is attached from the rear side of the vehicle. The back door is connected to the upper edge above the rear opening of the vehicle via the pair of left and right door hinges. The door hinges allow the back door to pivot about the upper edge above the rear opening of the vehicle, so that the back door can be opened or closed.

As shown in FIGS. 1 to 4, the skirt portion 30 is positioned closer to the bottom of the vehicle than is the opening 10. The skirt portion 30 forms a generally plate-like closure in the inner panel A10. The skirt portion 30 includes an under-opening lateral portion 31, a pair of connecting portions 32, a frame portion 33, a box-shaped bulging portion 35, and a skeletal portion 36.

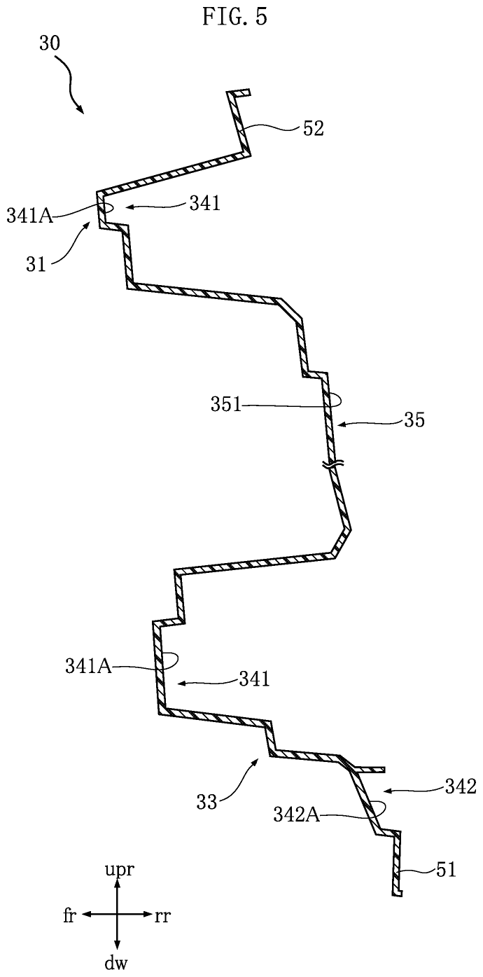

As shown in FIGS. 1 to 4, the lateral portion 31 is positioned at the upper end of the skirt portion 30, and extends in the vehicle width direction. As shown in FIG. 5, the lateral portion 31 is formed with a first recessed groove 341 that opens toward the rear side of the vehicle. The recessed groove 341 corresponds to the “recessed groove” in the claims of the present disclosure. The first recessed groove 341 has a bottom surface 341A facing the rear side of the vehicle. The bottom surface 341A is arranged to spread along the vehicle top-bottom direction and along the vehicle width direction.

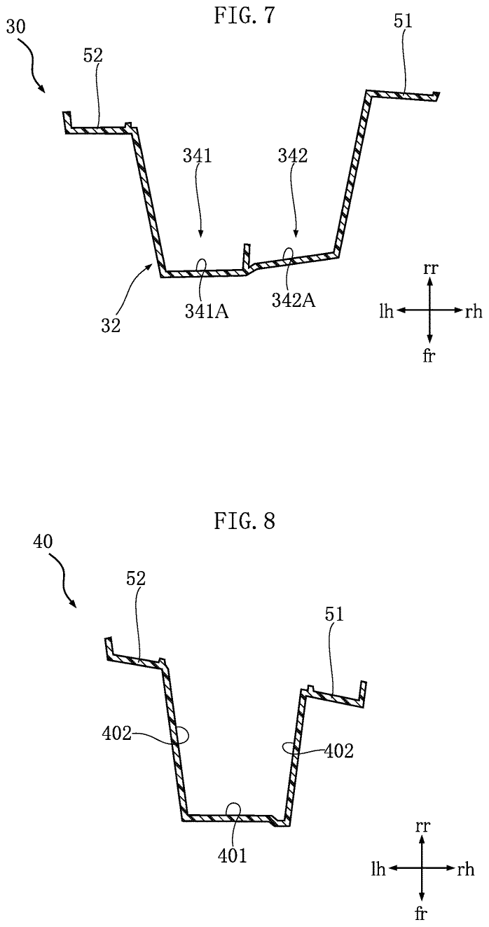

As shown in FIGS. 1 to 4, the pair of connecting portions 32 are positioned at the left and right sides of the lateral portion 31, and are connected to the lower ends of the pair of side portions 40. Each of the connecting portions 32 is provided with a damper stay (not shown) and a door stay reinforcing member made of steel (not shown). The damper stay is attached from the front side of the vehicle and the steel reinforcing member is attached from the rear side of the vehicle. Each of the connecting portions 32 has a door stay attachment hole 321 passing through in the vehicle's longitudinal direction for attaching the damper stay for the back door. As shown in FIG. 7, the connecting portion 32 with the first flange 51 and the second flange 52 has a hat-shaped cross section that is open toward the rear side of the vehicle. Due to the hat-shaped cross section, each of the connecting portions 32 is formed with the first recessed groove 341 and a second recessed groove 342, where the first recessed groove is open toward the rear side of the vehicle, and the second recessed groove 342 is positioned closer to the outer periphery of the inner panel A10 than is the first recessed groove 341 and is open toward the rear side of the vehicle. The second recessed groove 342 has a bottom surface 342A facing the rear side of the vehicle. The bottom surface 342A is arranged along the vehicle top-bottom direction and along the vehicle width direction.

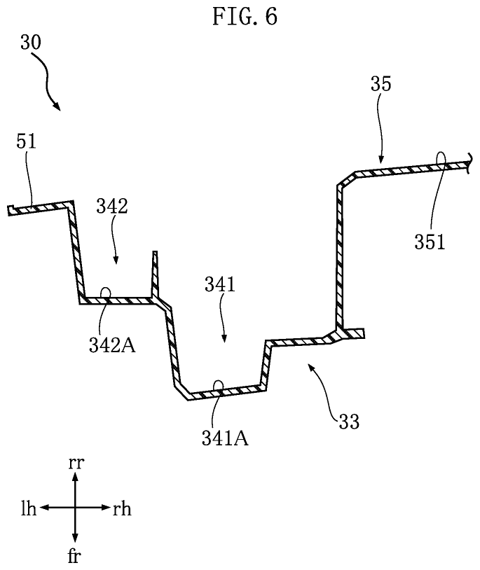

As shown in FIGS. 1 to 4, the frame portion 33 is positioned at the lower end and both left and right ends of the skirt portion 30, and is connected to the pair of connecting portions 32. As shown in FIGS. 5 and 6, the frame portion 33 is formed with the first recessed groove 341 and the second recessed groove 342 that are open toward the rear side of the vehicle. The lower end of the frame portion 33 is provided with a latch attachment portion 331. A latch (not shown) attached to the latch attachment portion 331 engages with a striker (not shown) provided at the lower edge of the rear opening of the vehicle, whereby the back door is kept to close the rear opening of the vehicle. The illustrated latch attachment portion 331 of the inner panel A10 is arranged in the middle of the lower end of the frame portion 33, but the position of the latch attachment portion 331 is not limited to this.

As shown in FIGS. 1 to 4, the first recessed groove 341 is formed in a frame shape (square shape) in the lateral portion 31, the pair of connecting portions 32, and the frame portion 33, as viewed from the rear side of the vehicle. As shown in FIGS. 5 to 7, the bottom surface 342A of the second recessed groove 342, at the pair of connecting portions 32 and the frame portion 33, is positioned closer to the rear of the vehicle than is the bottom surface 341A of the first recessed groove 341. The second recessed groove 342 is connected to the first flange 51 formed on the outer edge of the skirt portion 30.

As shown in FIGS. 1 to 6, the box-shaped bulging portion 35 is positioned in an area of the skirt portion 30 that is surrounded by the first recessed groove 341. The box-shaped bulging portion 35 bulges toward the rear side of the vehicle relative to the bottom surface 341A of the first recessed groove 341. The box-shaped bulging portion 35 is recessed toward the rear side of the vehicle, as viewed from the front side of the vehicle. Note that the first recessed groove 341 surrounding the box-shaped bulging portion 35 corresponds to the peripheral edge of the skirt portion 30. The box-shaped bulging portion 35 has a bulging surface 351 that faces the rear side of the vehicle and spreads along the vehicle top-bottom direction and along the vehicle width direction. When the inner panel A10 is joined to the outer panel, the box-shaped bulging portion 35 comes into contact with the outer panel via an adhesive (e.g., polyurethane-based adhesive) applied to the bulging surface 351.

As shown in FIGS. 1 to 4, the skeletal portion 36 is formed integral with the box-shaped bulging portion 35. The skeletal portion 36 is recessed from the bulging surface 351 of the box-shaped bulging portion 35 toward the front side of the vehicle, and is open toward the rear side of the vehicle. The skeletal portion 36 has a groove shape (U shape) in cross section. The skeletal portion 36 includes a left arm 361 at the left side of the latch attachment portion 331, and a right arm 362 at the right side of the latch attachment portion 331. As viewed from the front side of the vehicle, the left arm 361 and the right arm 362 each form a ridge that bulges from the box-shaped bulging portion 35. The skeletal portion 36 extends obliquely upward relative to the vehicle width direction, from both left and right sides of the latch attachment portion 331, and reaches the pair of connecting portions 32.

As shown in FIGS. 1 to 4, the pair of side portions 40 are positioned at the left and right sides of the opening 10 and extend in the vehicle top-bottom direction. The pair of side portions 40 provide a pillar structure in the inner panel A10. The pair of side portions 40 connect the upper portion 20 and the skirt portion 30. As shown in FIG. 8, each of the side portions 40 is open toward the rear side of the vehicle, and has a bottom surface 401 and a pair of inner side surfaces 402.

As shown in FIG. 8, the bottom surface 401 is arranged to spread along the vehicle top-bottom direction and along the vehicle width direction, and faces the rear side of the vehicle. The pair of inner side surfaces 402 are connected to the left and right ends of the bottom surface 401, and extend toward the rear side of the vehicle. The pair of inner side surfaces 402 face each other in the vehicle width direction. The rear end of an inner side surface 402, which is one of the inner side surfaces 402 that is positioned closer to the outer periphery of the inner panel A10, is connected to the first flange 51. The rear end of the other inner side surface 402, which is positioned closer to the inner periphery of the inner panel A10, is connected to the second flange 52. Accordingly, the side portion 40 with the first flange 51 and the second flange 52 has a hat-shaped cross section that is open toward the rear side of the vehicle.

As shown in FIGS. 1 to 4, the inner panel A10 has a pair of left and right skeletal structures including the pair of side portions 40, the pair of connecting portions 32, and the skeletal portion 36. The skeletal structures are continuous from the pair of door hinge attachment portions 21 provided at the upper portion 20 to the latch attachment portion 331 provided at the frame portion 33.

The following describes advantages of the inner panel A10.

The inner panel A10 is provided with a pair of left and right skeletal structures that include the side portions 40, the connecting portions 32 and the skeletal portion 36. These skeletal structures are continuous from the respective door hinge attachment portions 21 at the upper portion 20 to the latch attachment portion 331 at the skirt portion 30. Each of the side portions 40 and connecting portions 32 has a hat-shaped cross section that is open toward the rear side of the vehicle, and the skeletal portion 36 has a groove-shaped cross section that is open toward the rear side of the vehicle, so that these portions can provide relatively high rigidity in the inner panel A10. Accordingly, the skeletal structures can improve the rigidity (against the bending and twisting) of the inner panel A10 without a relatively heavy reinforcement. Furthermore, a reaction force acting on the latch attachment portion 331 when the backdoor is opened or closed can be transmitted to the respective door hinge attachment portions 21 through the skeletal structures, and further to the vehicle body via the door hinges. In this way, the skeletal structures contribute to reducing the reaction force acting on the inner panel A10. Accordingly, the inner panel A10 can have improved rigidity while reducing its weight.

In the skirt portion 30 of the inner panel A10, the lateral portion 31, the pair of connecting portions 32, and the frame portion 33 are each formed with the first recessed groove 341 that is open toward the rear side of the vehicle. While the box-shaped bulging portion 35 is positioned in the area of the skirt portion 30 surrounded by the first recessed groove 341, the skeletal portion 36 is formed in the box-shaped bulging portion 35. Hence, in addition to the skeletal portion 36 of certain rigidity, the skirt portion 30 can also have a frame-shaped skeletal structure surrounding the box-shaped bulging portion 35 as viewed from the rear side of the vehicle. This skeletal structure has relatively high rigidity in the skirt portion 30. Accordingly, it possible to improve the rigidity of the skirt portion 30 without a relatively heavy reinforcement.

The connecting portions 32 and the frame portion 33 are formed with the second recessed groove 342 that is positioned closer to the outer periphery of the inner panel A10 than is the first recessed groove 341. The bottom surface 342A of the second recessed groove 342 is disposed offset toward the rear side of the vehicle with respect to the bottom surface 341A of the first recessed groove 341. As such, the connecting portions 32 and the frame portion 33 have a double groove structure in which a step is provided by the first recessed groove 341 and the second recessed groove 342 in the vehicle longitudinal direction, thereby increasing the moment of inertia of area around the vehicle top-bottom direction. Hence, the double groove structure contributes to improving the rigidity of the skirt portion 30.

The present disclosure is not limited to the embodiments described above. Various design changes may be made to the specific configurations of the elements of the present disclosure.

The present disclosure includes embodiments according to the following clauses.

[Clause 1]

A vehicle back door inner panel containing synthetic resin as a constituent material, the inner panel comprising:

an opening for a back window to be provided;

an upper portion closer to a top of a vehicle than is the opening, the upper portion extending in a vehicle width direction and provided with a pair of door hinge attachment portions at left and right ends of the upper portion;

a skirt portion closer to a bottom of the vehicle than is the opening, and provided with a latch attachment portion at a lower end of the skirt portion; and

a pair of side portions disposed on left and right sides of the opening, respectively, each extending in a vehicle top-bottom direction and connecting the upper portion and the skirt portion,

wherein each of the side portions has a hat-shaped cross section that is open toward a rear side of the vehicle,

the skirt portion has a pair of connecting portions disposed at left and right sides of an upper end of the skirt portion, respectively, each of the connecting portions having a hat-shaped cross section that is open toward the rear side of the vehicle,

the connecting portions are connected to lower ends of the respective side portions,

the skirt portion further comprises a skeletal portion that is open toward the rear side of the vehicle,

the skeletal portion extends from left and right sides of the latch attachment portion and obliquely upward relative to the vehicle width direction to reach the connecting portions, and

a combination of the side portions, the connecting portions and the skeletal portion forms a pair of left and right skeletal structures that are continuous from the respective door hinge attachment portions to the latch attachment portion.

[Clause 2]

The vehicle backdoor inner panel according to clause 1,

wherein the skirt portion further comprises an under-opening lateral portion and a frame portion, the lateral portion being disposed between the connecting portions in the vehicle width direction, the frame portion being disposed along a lower end of the skirt portion and along left and right ends of the skirt portion, the frame portion being connected to the connecting portions,

each of the lateral portion, the connecting portions and the frame portion is formed with a recessed groove that is open toward the rear side of the vehicle,

the skirt portion further comprises a box-shaped bulging portion in an area surrounded by the recessed groove,

the box-shaped bulging portion bulges toward the rear side of the vehicle relative to a bottom surface of the recessed groove, and

the skeletal portion is formed in the box-shaped bulging portion.

1. A vehicle back door inner panel containing synthetic resin as a constituent material, the inner panel comprising:
an opening for a back window to be provided;
an upper portion closer to a top of a vehicle than is the opening, the upper portion extending in a vehicle width direction and provided with a pair of door hinge attachment portions at left and right ends of the upper portion;
a skirt portion closer to a bottom of the vehicle than is the opening, and provided with a latch attachment portion at a lower end of the skirt portion; and
a pair of side portions disposed on left and right sides of the opening, respectively, each extending in a vehicle top-bottom direction and connecting the upper portion and the skirt portion,
wherein each of the side portions has a hat-shaped cross section that is open toward a rear side of the vehicle,
the skirt portion has a pair of connecting portions disposed at left and right sides of an upper end of the skirt portion, respectively, each of the connecting portions having a hat-shaped cross section that is open toward the rear side of the vehicle,
the connecting portions are connected to lower ends of the respective side portions,
the skirt portion further comprises a skeletal portion that is open toward the rear side of the vehicle,
the skeletal portion extends from left and right sides of the latch attachment portion and obliquely upward relative to the vehicle width direction to reach the connecting portions, and
a combination of the side portions, the connecting portions and the skeletal portion forms a pair of left and right skeletal structures that are continuous from the respective door hinge attachment portions to the latch attachment portion.

2. The vehicle backdoor inner panel according to claim 1,
wherein the skirt portion further comprises an under-opening lateral portion and a frame portion, the lateral portion being disposed between the connecting portions in the vehicle width direction, the frame portion being disposed along a lower end of the skirt portion and along left and right ends of the skirt portion, the frame portion being connected to the connecting portions,
each of the lateral portion, the connecting portions and the frame portion is formed with a recessed groove that is open toward the rear side of the vehicle,
the skirt portion further comprises a box-shaped bulging portion in an area surrounded by the recessed groove,
the box-shaped bulging portion bulges toward the rear side of the vehicle relative to a bottom surface of the recessed groove, and
the skeletal portion is formed in the box-shaped bulging portion.
